(19) United States
(12) Patent Application Publication
(10) Pub. No.: US 2026/0039578 A1
(43) Pub. Date: Feb. 5, 2026

(54) LINK STATUS PROPAGATION IN NETWORK FABRIC CLUSTER

(71) Applicant: Cisco Technology, Inc., San Jose, CA (US)

(72) Inventors: Sunesh Rustagi, San Ramon, CA (US); Praveen Bhagwatula, Cary, NC (US); Tapraj Singh, San Ramon, CA (US); Prashanth Buddhala, San Ramon, CA (US); Vijay Tapaskar Krishnaji, Palo Alto, CA (US)

(21) Appl. No.: 18/793,697

(22) Filed: Aug. 2, 2024

(51) Int. Cl. H04L 45/03; H04L 45/00; H04L 47/34

(52) U.S. Cl. CPC H04L 45/03; H04L 45/22; H04L 47/34

(57) ABSTRACT

Devices, systems, methods, and processes for link status propagation are provided. In modern networks, transmitting a single bit of information about link status of each host-side link in the network may require a large amount of data, consuming considerable bandwidth and processing power. To address these concerns, a network device having a plurality of host-side ports coupled to same ordinal processing units in a set of host devices and associated with a rail identifier is provided. The network device determines first link status information associated with communication links of the network device and receives second link status information from other network devices having rail identifiers that match the rail identifier of the network device. The network device transmits the first and second link status information to the same ordinal processing units and a host device aggregates link status information received at corresponding processing units to obtain a cluster wide view.

The present disclosure relates to communication networks. More particularly, the present disclosure relates to link status propagation in a network fabric.

### BACKGROUND

Network fabric with spine-leaf architecture has gained significant popularity in modern communication networks due to its high-performance and low-latency connectivity. Further, such an architecture supports scaling, which allows the network fabric to grow as and when required without major reconfiguration. Additionally, the spine-leaf architecture offers built-in redundancy and high availability, enhancing network reliability.

An endpoint server, connected to a network fabric with the spine-leaf architecture, might require information on link statuses of host-facing links of leaf switches to ensure optimal performance and reliability. Such information may allow endpoint servers to dynamically adapt to changes in network topology, such as link failures or congestion, which can impact data throughput and latency.

However, frequent communication of link status information may consume significant bandwidth and processing power, potentially impacting the performance of the network fabric. For example, a network fabric with 32K Graphics Processing Units “GPUs” cluster configuration can have 256 spine switches, 512 leaf switches, and 4,096 endpoint servers each having 8 GPUs. Further, each leaf switch may connect to 64 GPUs and 256 spine switches. Additionally, each spine switch may connect to 512 leaf switches. Therefore, the network fabric can have 32,768 ports toward hosts (for example, endpoint servers). In this network configuration, transmitting a single bit of information about link status (e.g., whether the link is up or down) for each of the 32,768 ports may require communication of 4,096 bytes of data. Transferring such a large amount of data across all leaf switches and endpoint servers may adversely affect various aspects of the network fabric, for example, throughput, latency, checkpoint, workload resumption, or the like, which is undesirable.

### SUMMARY OF THE DISCLOSURE

Devices and methods for link status propagation in network fabric clusters, in accordance with embodiments of the disclosure, are described herein. In many embodiments, a network device including a processor, a plurality of ports coupled to same ordinal processing units in a set of host devices in a rail-based network topology, and a memory communicatively coupled to the processor, is provided. The memory includes a link status propagation logic that is configured to determine first link status information of the network device. The network device is associated with a rail identifier. The link status propagation logic is further configured to receive second link status information of one or more other network devices that have rail identifiers matching the rail identifier of the network device and transmit the first link status information and the second link status information to the same ordinal processing units.

In a number of embodiments, the link status propagation logic transmits the first link status information and the second link status information to the same ordinal processing units via a Link Layer Discovery Protocol (LLDP) message.

In a variety of embodiments, the first link status information and the second link status information are included in an Organizationally Unique Identifier (OUI) Type-Length-Value (TLV) field of the LLDP message.

In more embodiments, the link status propagation logic is further configured to transmit a message to the one or more other network devices that have the rail identifiers matching the rail identifier of the network device. The message is configured to indicate the first link status information.

In further embodiments, the message includes a sequence identifier configured to maintain an order of delivery.

In additional embodiments, the message is further configured to indicate the rail identifier of the network device.

In still more embodiments, the network device and the set of host devices are a part of a server plane.

In yet more embodiments, the message is further configured to indicate a server plane identifier associated with the server plane.

In still yet more embodiments, the memory is further configured to store a link status database.

In many further embodiments, the link status propagation logic is further configured to store the first link status information and the second link status information in the link status database.

In further additional embodiments, the link status propagation logic is further configured to update the link status database in response to receiving the second link status information.

In still further embodiments, the link status propagation logic is further configured to update the link status database in response to determining the first link status information.

In several embodiments, the plurality of ports are coupled to the same ordinal processing units via a set of communication links.

In several additional embodiments, the first link status information is configured to indicate a status of at least one of the set of communication links.

In numerous embodiments, the status is one of active or inactive.

In numerous additional embodiments, the first link status information and the second link status information are transmitted to the same ordinal processing units via the set of communication links.

In several more embodiments, the network device is a leaf node in a Disaggregated Scheduled Fabric (DSF) cluster.

In yet additional embodiments, a host device including one or more processing units and memory communicatively coupled to the one or more processing units, is provided. Each of the one or more processing units is coupled to a distinct network node having a distinct rail identifier. The memory includes a link status propagation logic that is configured to receive, at each of the one or more processing units, link status information of the distinct network node and a set of other network nodes that have rail identifiers matching the distinct rail identifier and aggregate the link status information received at each of the one or more processing units.

In still additional embodiments, the memory further includes a link status database configured to store the aggregated link status information.

In still yet additional embodiments, a link status propagation method includes determining first link status information of a network device in a network. The network device is associated with a rail identifier and coupled to same ordinal processing units in a set of host devices. The method further includes receiving second link status information of one or more other network devices, in the network, that have rail identifiers matching the rail identifier of the network device and transmitting the first link status information and the second link status information to the same ordinal processing units.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is a schematic block diagram of an example communication network including a network fabric in accordance with various embodiments of the disclosure;

FIG. 3 is a schematic block diagram of an example communication network for propagating link status information in accordance with various embodiments of the disclosure;

FIG. 4 is a schematic block diagram of a network device in accordance with various embodiments of the disclosure;

FIG. 5 is a schematic diagram of a host device in accordance with various embodiments of the disclosure;

FIG. 6 is a flowchart showing a process for propagating link status information in a network fabric cluster in accordance with various embodiments of the disclosure;

FIG. 7 is a flowchart showing a process for propagating link status information in a network fabric cluster in accordance with various embodiments of the disclosure;

FIG. 8 is a flowchart showing a process for aggregating cluster wide link status information in a host device in accordance with various embodiments of the disclosure; and

FIG. 9 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements to facilitate understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can perform link status propagation in a network fabric cluster. The network fabric can be based on spine-leaf topology. Typically, in the network fabric utilizing the spine-leaf topology, servers may require link status information to dynamically adapt to changes in network topology, such as link failures or congestion. However, frequent communication of link status information to the servers can pose significant challenges. For example, a 32K Graphics Processing Units “GPUs” cluster design may include 256 spine switches, 512 leaf switches, and 4,096 servers (each including 8 GPUs). Each leaf switch may connect to 64 GPUs and 256 spine switches, while each spine switch may connect to 512 leaf switches. Such a configuration requires 32,768 ports connecting host devices, such as servers, to the 512 leaf switches. In this network configuration, transmitting a single bit of information about link status (e.g., whether the link is up or down) for each of the 32,768 ports may require communication of 4,096 bytes of data. Transmitting such a large amount of data across all leaf switches and servers can adversely affect various aspects of the network fabric, including throughput, latency, checkpointing, and workload resumption. Further, transmitting such a large amount of data may consume considerable bandwidth and processing power, which is undesirable.

To address these concerns, the devices and methods discussed herein optimize the propagation of link status information by reducing the amount of data being transmitted by each leaf switch. In many embodiments, the network fabric can be a Disaggregated Scheduled Fabric (DSF) cluster. DSF cluster is a spine-leaf topology that leverages disaggregated components including spine switches, leaf switches, and interconnecting cables. The spine switches primarily function as fabric devices, while the leaf switches form the network's edge. The leaf switches may be interconnected through the spine switches. In various embodiments, the spine-leaf topology can be built on a rail-based network architecture. In the rail-based network architecture, the same ordinal GPUs <n> from all servers (e.g., host devices, endpoint devices, or the like) may be connected to the same leaf switch. Same ordinal GPUs may refer to GPUs with the same position, designated identifier, or role across different servers. A connection between a leaf switch and a GPU may be referred to as a “link”. Continuing the above example of a 32K GPU cluster, if a leaf switch has 64 host-facing ports, in the rail-based network architecture, the leaf switch is connected to the same ordinal GPUs <n> of 64 servers. Further, if a server has 8 GPUs, each GPU may be connected to a different leaf switch and the server may be connected to 8 leaf switches. A combination of 64 servers connected to 8 leaf switches, with each leaf switch being connected to the same ordinal GPUs <n> from all 64 servers may be referred to as a “server plane”. In the 32K GPU cluster example, the communication network may include 64 server planes. Within a server plane, each leaf switch may be referred to as a rail and may be associated with a distinct rail identifier (ID). While rail IDs within a server plane are distinct, they can be reused across different server planes. For example, 8 leaf switches in a server plane may be assigned with rail IDs ‘R1’ through ‘R8’, respectively. The same 8 rail IDs can be re-used in the remaining 63 server planes of the communication network.

In a number of embodiments, each link in the communication network may have an active status or an inactive status. The leaf switches in the network fabric may propagate link status information to the servers. The link status information may be indicative of a current status of a plurality of links (e.g., 32,768 links in the 32K GPU cluster) between the leaf switches and the GPUs. In a variety of embodiments, the link status information associated with the leaf switches may be propagated to the servers on a rail basis. For example, a leaf switch with a rail ID ‘R1’ may propagate its link status information (referred to as “first LSI”) along with link status information of other leaf switches having the same rail ID (referred to as “second LSI”) to a connected GPU. Thus, each leaf switch in a server plane determines the first LSI, receives the second LSI from one or more other leaf switches having the same rail ID, and transmits the first LSI and the second LSI to the connected GPU. Since each GPU in a server is connected to a different leaf switch in a server plane, all GPUs in the server may collectively receive the first LSI and the second LSI for all rail IDs. Subsequently, each server may aggregate the first LSI and the second LSI received at each GPU to determine the link status information of all leaf switches in the network fabric.

In the above-described devices and methods, each leaf switch, instead of communicating the link status information of all leaf switches, communicates link status information on a rail basis. In other words, a leaf switch communicates link status information associated with corresponding links along with link status information of links of other leaf switches with rail IDs the same as a rail ID of the leaf switch. Such rail-based communication of the link status information by leaf switches significantly reduces the amount of data that each leaf switch may be required to transmit to the connected servers (e.g., host devices). In addition, transmission of a reduced amount of data may also reduce transmission time and may exhibit significantly reduced latency, allowing GPUs to checkpoint sooner and resume workload.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in various embodiments, may alternatively be embodied by or implemented as a component.

A circuit, as used herein, comprises a set of one or more electrical and/or electronic components providing one or more paths for electrical current. In certain embodiments, a circuit may include a return path for electrical current, so that the circuit is a closed loop. In another embodiment, however, a set of components that does not include a return path for electrical current may be referred to as a circuit (e.g., an open loop). For example, an integrated circuit may be referred to as a circuit regardless of whether the integrated circuit is coupled to the ground (as a return path for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

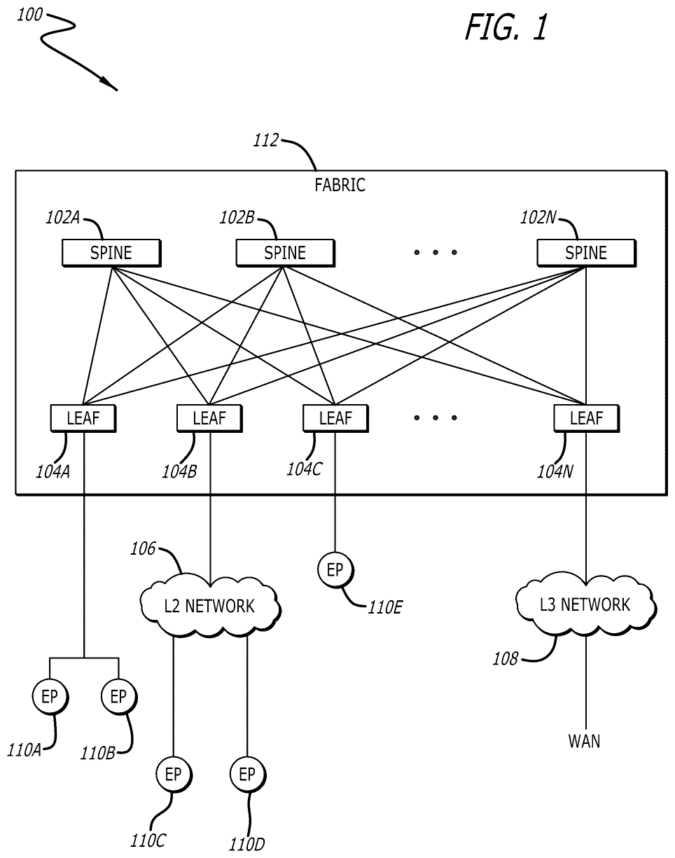

Referring to FIG. 1, a schematic block diagram of an example architecture 100 for a network fabric 112 in accordance with various embodiments of the disclosure is shown. The network fabric 112 can include spine switches 102A. 102B, . . . 102N (collectively “102”) connected to leaf switches 104A. 104B, 104C, . . . 104N (collectively “104”) in the network fabric 112. As those skilled in the art will recognize, networking fabric can refer to a high-speed, high-bandwidth interconnect system that enables multiple devices to communicate with each other efficiently and reliably. It is a network topology that is designed to provide a flexible and scalable infrastructure for data center, cloud environments, and other network elements.

Various embodiments described herein can include a leaf-spine architecture comprising a plurality of spine switches (also referred to as spine nodes) and leaf switches (also referred to as leaf nodes). Spine switches 102 can be L3 switches in the fabric 112. An L3 switch, or Layer 3 switch, is a networking device that operates at a network layer (Layer 3) of the Open Systems Interconnection (OSI) model. However, in some cases, the spine switches 102 can also, or otherwise, perform L2 (e.g., Layer 2 of the OSI model) functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In various embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of the endpoint address identifier (ID) to locator mapping in a mapping database on behalf of leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102;, wherein subscript “i” indicates that this operation may occur at any spine switch 102A to 102N, the spine switch 102; can first check if the destination locator address is a proxy address. If so, the spine switch 102; can perform the proxy function as previously mentioned. If not, the spine switch 102; can look up the locator in its forwarding table and forward the packet accordingly.

In a number of embodiments, one or more spine switches 102 can connect to one or more leaf switches 104 within the fabric 112. Leaf switches 104 can include access ports (or non-fabric ports) and fabric ports. Fabric ports can provide uplinks to the spine switches 102, while access ports can provide connectivity for devices, hosts, endpoints, VMs, or external networks to the fabric 112.

In more embodiments, leaf switches 104 can reside at the edge of the fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulating packets, enforcing ingress or egress policies, etc. Moreover, the leaf switches 104 can contain virtual switching functionalities, such as a virtual tunnel endpoint (VTEP) function. Further, leaf switches 104 can connect the fabric 112 to an overlay network.

In further embodiments, network connectivity in the fabric 112 can flow through the leaf switches 104. Here, the leaf switches 104 can provide servers, resources, endpoints, external networks, or VMs access to the fabric 112, and can connect the leaf switches 104 to each other. In some cases, the leaf switches 104 can connect endpoint groups to the fabric 112 and/or any external networks. Each endpoint group can connect to the fabric 112 via one of the leaf switches 104, for example.

Endpoints 110 A-E (collectively “110”, shown as “EP”) can connect to the fabric 112 via leaf switches 104. For example, endpoints 110A and 110B can connect directly to leaf switch 104A, which can connect endpoints 110A and 110B to the fabric 112 and/or any other one of the leaf switches 104. Similarly, endpoint 110E can connect directly to leaf switch 104C, which can connect endpoint 110E to the fabric 112 and/or any other of the leaf switches 104. On the other hand, endpoints 110C and 110D can connect to the leaf switch 104B via L2 network 106. Similarly, the wide area network (WAN) can connect to one or more of the leaf switches 104 (e.g., leaf switch 104N) via L3 network 108.

In various embodiments, endpoints 110 can include any communication devices, such as computers, servers, switches, routers, graphics processing units (GPUs), etc. In some cases, the endpoints 110 can include a server, hypervisor, or switch configured with a VTEP functionality which connects an overlay network with the fabric 112. The overlay network can host physical devices, such as servers, applications, endpoint groups, virtual segments, virtual workloads, etc. In addition, the endpoints 110 can host virtual workload(s), clusters, and applications or services, which can connect with the fabric 112 or any other device or network, including an external network. For example, one or more endpoints 110 can host, or connect to, a cluster of load balancers or an endpoint group of various applications.

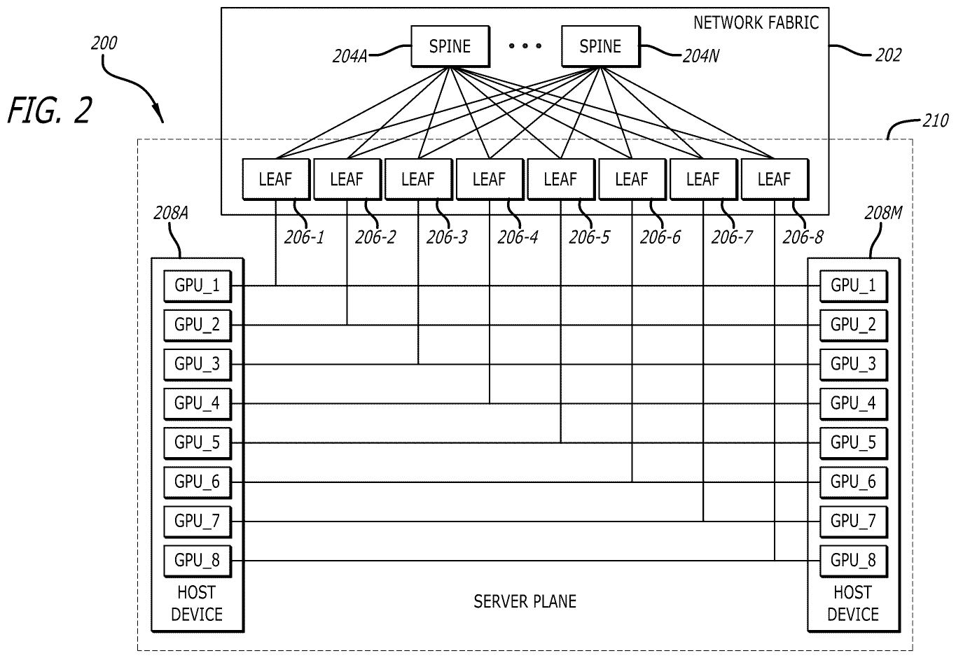

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-9 as required to realize a particularly desired embodiment.

Referring to FIG. 2, a schematic block diagram of an example communication network 200 including a network fabric 202 in accordance with various embodiments of the disclosure is shown. In an example scenario depicted in FIG. 2, the network fabric 202 is shown to include a plurality of spine nodes 204A-N connected to a plurality of leaf nodes 206-1-206-8. The example communication network 200 further includes a plurality of host devices 208A-M (collectively “208”) that connect to the network fabric 202 via the plurality of leaf nodes 206-1-206-8. The network fabric 202 can refer to a high-speed, high-bandwidth interconnect system that enables multiple devices to communicate with each other efficiently and reliably.

The plurality of spine nodes 204A-N can be L3 switches in the network fabric 202. An L3 switch, or Layer 3 switch, is a network device that operates at a network layer (Layer 3) of the Open Systems Interconnection (OSI) model. However, in some cases, the plurality of spine nodes 204A-N can also, or otherwise, perform L2 (e.g., Layer 2 of the OSI model) functionalities. Further, the plurality of spine nodes 204A-N can support various capabilities, such as, but not limited to, 40 or 10 Gbps Ethernet speeds. In a number of embodiments, one or more spine nodes can connect to one or more leaf nodes within the network fabric 202. For example, the spine node 204A may be coupled with the plurality of leaf nodes 206-1-206-8.

The plurality of leaf nodes 206-1-206-8 are network switches (or network devices) that reside at the edge of the network fabric 202 and can thus represent the physical network edge. In a variety of embodiments, the plurality of leaf nodes 206-1-206-8 can include host-side ports (also referred to as non-fabric ports) and network-side ports (also referred to as fabric ports). The network-side ports can provide uplinks to the plurality of spine nodes 204A-N, while the host-side ports can provide connectivity for the plurality of host devices 208A-M.

In many embodiments, the plurality of host devices 208A-M can include any communication devices, such as computers, servers, switches, routers, etc. In some cases, the endpoints 110 can include a server, hypervisor, or switch configured with a VTEP functionality which connects an overlay network with the network fabric 202. The overlay network can host physical devices, such as servers, applications, endpoint groups, virtual segments, virtual workloads, etc. In addition, the plurality of host devices 208A-M can host virtual workload(s), clusters, and applications or services, which can connect with the network fabric 202 or any other device or network, including an external network. In numerous embodiments, each host device 208A-M may include one or more processing units (for example, Graphics Processing Units “GPUs”). As shown in FIG. 2, each host device 208A-M includes eight processing units, for example, GPU_1-GPU_8.

In several embodiments, the communication network 200 can be implemented as a rail-based network architecture. In the rail-based network architecture, the same ordinal GPUs <n> in the plurality of host devices 208A-M may be coupled with the same leaf node via the host-side ports of the leaf node. For example, all GPU_1s of the plurality of host devices 208A-M are coupled to the same leaf node 206-1. Similarly, all GPU_8s of the plurality of host devices 208A-M are coupled to the same leaf node 206-8. Here, the same ordinal GPUs <n> may refer to GPUs with the same position, designated identifier, or role across different host devices 208A-M. Further, a connection between a host-side port of a leaf node and a GPU may be referred to as a “communication link”. In other words, the same ordinal GPUs in the plurality of host devices 208A-M may be coupled with the same leaf node via a set of communication links.

In more embodiments, a combination of the plurality of host devices 208A-M connected to the plurality of leaf nodes 206-1-206-8, with each leaf node 206-1-206-8 being connected to the same ordinal GPUs <n> from the plurality of host devices 208A-M may form a server plane 210. The server plane 210 may be associated with a server plane identifier (ID) that uniquely identifies the server plane 210.

In additional embodiments, within the server plane 210, each leaf node 206-1-206-8 may be referred to as a rail and may be associated with a distinct rail ID. For example, the plurality of leaf nodes 206-1-206-8 in the server plane 210 may be assigned with distinct rail IDs ‘R1’ through ‘R8’, respectively. In further embodiments, each leaf node 206-1-206-8 can be referenced by the corresponding rail ID.

Although a specific embodiment for a communication network 200 suitable for carrying out the various steps, processes, methods, and operations described herein is discussed with respect to FIG. 2, any of a variety of systems and/or processes may be utilized in accordance with embodiments of the disclosure. For example, in many further embodiments, the network fabric 202 may be a Disaggregated Scheduled Fabric (DSF) cluster built on rail-based network architecture. The elements depicted in FIG. 2 may also be interchangeable with other elements of FIGS. 1 and 3-9 as required to realize a particularly desired embodiment.

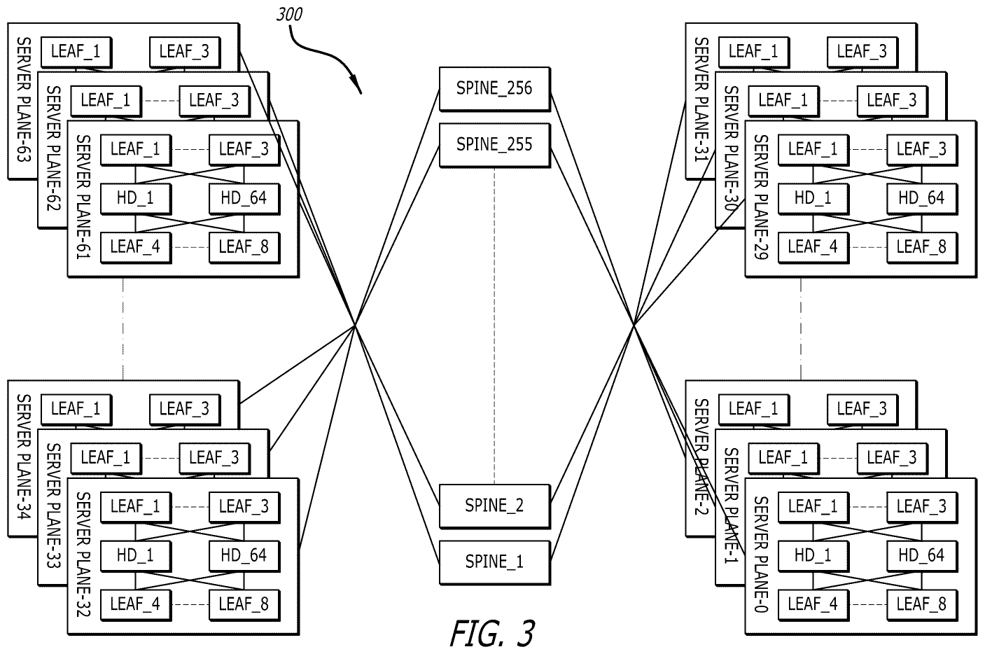

Referring to FIG. 3, a schematic block diagram of an example communication network 300 for propagating link status information in accordance with various embodiments of the disclosure is shown. In a non-limiting example and for the sake of brevity, the communication network 300 is described with respect to a 32K GPU cluster. It will be apparent to a person skilled in the art that the configuration of the communication network 300 can vary based on cluster size, such as 8K GPU cluster, 16K GPU cluster, 64K GPU cluster, or the like.

In many embodiments, the communication network 300 with the 32K GPU cluster configuration may include 32,768 GPUs, 512 leaf nodes, and 256 spine nodes (e.g., Spine_1-Spine_256). In further embodiments, with 8 GPUs integrated into one host device (e.g., a server), the communication network 300 may include 4,096 host devices.

In more embodiments, each leaf node may include a plurality of ports with 400 Gigabit connectivity, for example, 128 ports. Of these 128 ports, 64 ports can function as host-side ports, connecting to 64 GPUs. With 512 leaf nodes in the communication network 300, a total of 32,768 ports may be dedicated for host-side connections. Further, the remaining 64 ports in each leaf node can be split to support 100 Gigabit connectivity for network side connections. For example, the remaining 64 ports can be split into 256 ports with 100 Gigabit connectivity. These 256 ports can function as network-side ports, connecting to 256 spine nodes. In a number of embodiments, each spine node (e.g., Spine_1-Spine_256) may include 512 ports, connecting to 512 leaf nodes.

In a variety of embodiments, the communication network 300 may be organized into a plurality of server planes. Each server plane may include one or more leaf nodes connected to one or more host devices. For example, the communication network 300 with the 32K GPU cluster configuration may include 64 server planes (e.g., Server Plane-0-Server Plane-63). Further, each server plane may include 8 leaf nodes (denoted as Leaf_1-Leaf_8) connected to 64 host devices (denoted as HD_1-HD_64).

In additional embodiments, the communication network 300 can be implemented as a rail-based network architecture. In the rail-based network architecture, within each server plane, the same ordinal GPUs <n> in the 64 host devices (e.g., HD_1-HD_64) may be coupled with host-side ports of the same leaf node via a set of communication links. In still more embodiments, within a server plane (e.g., Server Plane-0-Server Plane-63), each leaf node (for example, Leaf_1-Leaf_8) may be referred to as a rail and may be associated with a distinct rail ID. While rail IDs within a server plane are distinct, they can be reused across different server planes. For example, Leaf_1-Leaf_8 in the Server Plane-0 may be assigned with rail IDs ‘R1’ through ‘R8’, respectively. The same 8 rail IDs (e.g., ‘R1’ through ‘R8’) can be assigned to Leaf_1-Leaf_8, respectively, in the Server Plane-1-Server Plane-63. In further additional embodiments, each server plane (e.g., Server Plane-0-Server Plane-63) may be associated with a server plane ID that uniquely identifies the corresponding server plane. Additionally, each leaf node (e.g., Leaf_1-Leaf_8) and host device (e.g., HD_1-HD_64) in a server plane (e.g., Server Plane-0-Server Plane-63) may be associated with the same server plane ID, indicating association with the same server plane.

In still further embodiments, link status information of the host-side ports in the communication network 300 may be required to ensure optimal performance and reliability. For example, link status of a communication link connecting a leaf node to a GPU can be active or inactive. The leaf node may communicate with the connected GPU based on the active status of the communication link. Awareness regarding the link statuses of the leaf nodes in the communication network 300 may allow networking and host devices in the communication network 300 to dynamically adapt to link failures or congestion, significantly impacting data throughput and latency. Therefore, the latest link status information of all communication links in the communication network 300 may be required to be provided to each host device. Traditionally, communication of the link status information may consume significant bandwidth and processing power, potentially impacting the performance of network fabric and GPUs. For example, in the communication network 300 with the 32K GPU cluster configuration, transmitting a single bit of information about link status (e.g., whether the link is up or down) for each of the 32,768 host-side ports may require communication of 4,096 bytes of data. Transferring such a large amount of data across all leaf nodes and host devices can adversely affect various aspects of the communication network 300, such as throughput, latency, checkpointing, workload resumption, and or the like.

In several embodiments, the present disclosure may address the abovementioned issues by communicating minimum information to each host device on a per-link basis for link status propagation. For example, on each communication link, instead of transmitting link status information of all 32,768 host-side ports, link status information pertaining to a specific rail ID can be transmitted. In other words, if 8 rail IDs are being reused across the 64 server planes, a communication link connected to Leaf_1 having rail ID ‘R1’ can be utilized to transmit link status information of all Leaf_1s in the communication network 300 that have the same rail ID ‘R1’. Likewise, a communication link connected to Leaf_8 having rail ID ‘R8’ can be utilized to transmit link status information of all Leaf_8s in the communication network 300 that have the same rail ID ‘R8’. In other words, each communication link is only required to transmit 4,096/8 bytes (i.e., 512 bytes) of data for propagating link status information. Since a host device (e.g., HD_1-HD_64) in a server plane (e.g., Server Plane-0-Server Plane-63) is connected to 8 leaf nodes (Leaf_1-Leaf_8) having rail IDs ‘R1’ through ‘R8’, respectively, the host device may receive link status information pertaining to all IDs ‘R1’ through ‘R8’ via the 8 communication links. Consequently, each host device (e.g., HD_1-HD_64) in a server plane (e.g., Server Plane-0-Server Plane-63) may receive 4,096 bytes (i.e. 512 bytes multiplied by 8) representing link status information of 32,768 host-side ports. In other words, the leaf nodes in the communication network 300 may only perform rail-based tracking for link status information, while the host devices (e.g., HD_1-HD_64 in Server Plane-0-Server Plane-63) may aggregate link status information pertaining to all rail IDs. In addition, each leaf node (e.g., Leaf_1-Leaf_8) in a server plane (e.g., Server Plane-0-Server Plane-63) is only required to transmit 8 bytes of data to other leaf nodes having the matching rail ID and receive 504 bytes of data from the other leaf nodes having the matching rail ID. Thus, if a server plane (e.g., Server Plane-0-Server Plane-63) has eight leaf nodes (e.g., Leaf_1-Leaf_8), each transmitting 8 bytes of data for a specific rail ID, a total of 64 bytes (8 leaf nodes*8 bytes) of data is being transmitted by a single server plane. In many further embodiments, the link status information transmitted by each leaf node (e.g., Leaf_1-Leaf_8) in a server plane (e.g., Server Plane-0-Server Plane-63) is associated with a unique server plane ID. In numerous embodiments, each leaf node (e.g., Leaf_1-Leaf_8) in a server plane (e.g., Server Plane-O-Server Plane-63) may transmit the 8 bytes of data to other leaf nodes having the matching rail ID and receive 504 bytes of data from the other leaf nodes having the matching rail ID, via the spine nodes (e.g., Spine_1-Spine_256). The leaf nodes (e.g., Leaf_1-Leaf_8) in each server plane (e.g., Server Plane-0-Server Plane-63) may utilize existing communication protocols or define new communication protocols for exchanging the link status information across the leaf nodes of different server planes (e.g., Server Plane-0-Server Plane-63).

Although a specific embodiment of a communication network 300 for propagating link status information suitable for carrying out the various steps, processes, methods, and operations described herein is discussed with respect to FIG. 3, any of a variety of systems and/or processes may be utilized in accordance with embodiments of the disclosure. For example, in numerous embodiments, a number of GPUs coupled to a leaf node may be limited by a number of host-side ports and connectivity in the leaf node. The elements depicted in FIG. 3 may also be interchangeable with other elements of FIGS. 1, 2, and 4-9 as required to realize a particularly desired embodiment.

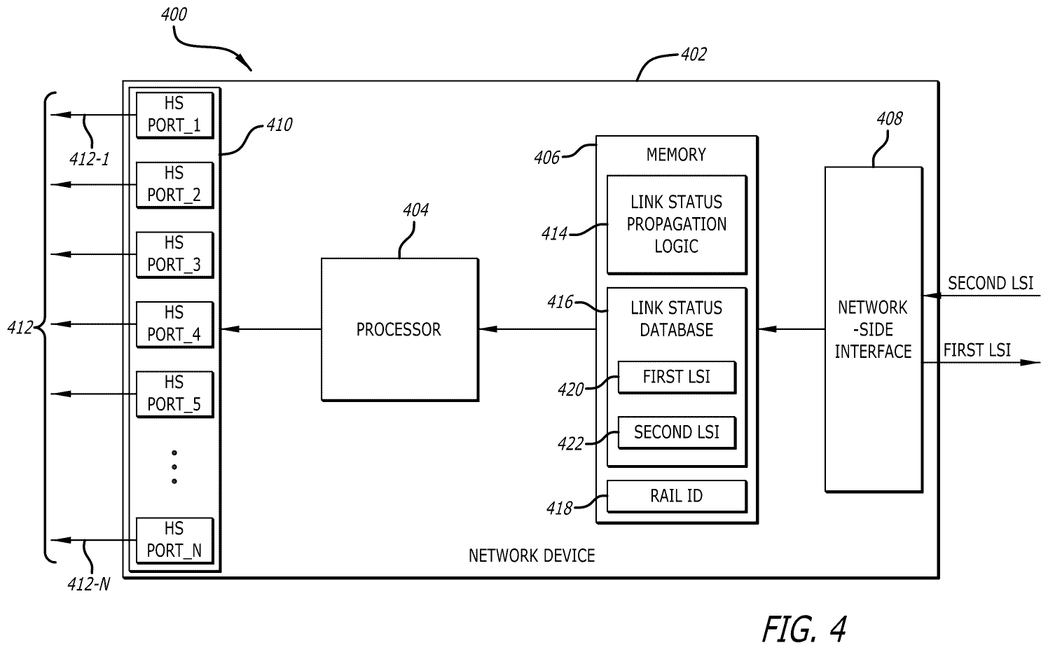

Referring to FIG. 4, a schematic block diagram 400 of a network device 402 in accordance with various embodiments of the disclosure is shown. In the embodiments shown in FIG. 4, the network device 402 may be a leaf node (e.g., a leaf switch) in a DSF cluster. The network device 402 may include a processor 404, a memory 406, a network-side interface 408, and a host-side interface 410. The processor 404 may be coupled with the memory 406 and the host-side interface 410. The host-side interface 410 may include a plurality of host-side ports (e.g., HS Port_1-HS Port_N) coupled with same ordinal processing units (for example, GPUs) of a set of host devices (for example, servers) in a rail-based network topology. The plurality of host-side ports (e.g., HS Port_1-HS Port_N) may be coupled with the same ordinal processing units via communication links 412-1-412-N, respectively. The communication links 412-1-412-N may be collectively referred to and designated as the communication links 412.

In various embodiments, the processor 404 may be implemented as one or more microprocessors, microcomputers, microcontrollers, digital signal processors, central processing units, logic circuitries, and/or any devices that process data based on operational instructions. Among other capabilities, the processor 404 may be configured to fetch and execute computer-readable instructions stored in the memory 406 of the network device 402. Further examples of the processor 404 may include an Application-Specific Integrated Circuit (ASIC) processor, a Reduced Instruction Set Computing (RISC) processor, a Complex Instruction Set Computing (CISC) processor, a Field-Programmable Gate Array (FPGA), or the like.

In several embodiments, the memory 406 may be configured to store one or more computer-readable instructions or routines in a non-transitory computer-readable storage medium, which may be fetched and executed for link status information propagation. The memory 406 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memory 406 in the network device 402, as described herein. In a variety of embodiments, the memory 406 may be realized in the form of a database server or a cloud storage working in conjunction with the network device 402, without departing from the scope of the disclosure.

In many embodiments, the memory 406 may be configured to include a link status propagation logic 414 and a link status database 416. The memory 406 may be further configured to store a rail ID 418 associated with (or assigned to) the network device 402. The link status propagation logic 414 may include suitable logic, circuitry, interfaces, and/or code, executable by the circuitry, which may be configured to perform one or more operations for link status information propagation.

In a number of embodiments, the link status propagation logic 414 can include various hardware and/or software deployments and can be configured in a variety of ways. The link status propagation logic 414 may be configured to determine first link status information (denoted as first LSI 420 in FIG. 4) associated with the communication links 412 of the network device 402. The first LSI 420 may be indicative of a link status (e.g., active or inactive) of at least one of the communication links 412 of the network device 402. In numerous embodiments, the link status propagation logic 414 may be configured to utilize one or more techniques for determining the first LSI 420, for example, Link Layer Discovery Protocol (LLDP) messaging, Ethernet link status monitoring, monitoring protocol-specific keepalive messages, Simple Network Management Protocol (SNMP) messaging, or the like. In an example, by monitoring LLDP packets exchanged between the network device 402 and the set of host devices via the communication links 412, the link status propagation logic 414 can determine a status (active or inactive) of the communication links 412. If the network device 402 ceases to receive LLDP packets from a specific host device, the link status propagation logic 414 can infer that a communication link 412 is inactive. In more embodiments, the link status propagation logic 414 may be further configured to store the first LSI 420 in the link status database 416.

In still more embodiments, the network device 402 may be configured to update the link status database 416 in response to determining the first LSI 420. The first LSI 420 may be determined periodically or based on a change in the link status of at least one of the communication links 412. In an example, the change in the link status can be from active to inactive or vice versa. The link status database 416 may be updated by incorporating the change in the link status in the link status database 416. The change in the link status may be determined by comparing the first LSI 420 with a previously determined first LSI stored in the link status database 416. Alternatively, the link status database 416 may be updated by replacing the previously determined first LSI with the first LSI 420.

In further embodiments, the network device 402 may be further configured to transmit, via the network-side interface 408 and one or more spine nodes connected to the network device 402, a message indicative of the first LSI 420 to one or more other network devices. The other network devices may be leaf nodes in the DSF cluster that may be associated with rail IDs that match the rail ID 418 of the network device 402. In an example, the message may include a State Information Field configured to indicate the first LSI 420. The State Information Field can be 64 bytes long. The message may further include a sequence field to indicate a sequence ID. The sequence ID may be one byte long and may be utilized for maintaining an order of delivery of the message. An out-of-order sequence ID may be indicative of a missing message or a stale message. A message with a sequence ID, which may be older than a sequence ID of a previously received message, may be discarded. The sequence ID may indicate the relevance and timeliness of the first LSI 420. The message may further indicate the rail ID 418 associated with the network device 402. Therefore, another network device may utilize the message based on a match of the corresponding rail ID with the rail ID 418 included in the message. In addition, the message may further indicate a server plane ID associated with the network device 402. Notably, the server plane ID may be configured to uniquely identify a server plane to which the network device 402 belongs. In an example, the server plane ID can be two bytes long. In numerous embodiments,

In additional embodiments, the network device 402 may be further configured to receive, via the network-side interface 408, second link status information (denoted as “second LSI 422”) from the one or more other network devices in the DSF cluster. For example, the second LSI 422 may be configured to indicate link status information of communication links of the one or more other network devices that have rail IDs that match the rail ID 418 of the network device 402. The network device 402 may store the second LSI 422 in the link status database 416.

In still further embodiments, the network device 402 may be configured to update the link status database 416 in response to receiving the second LSI 422. The second LSI 422 may be received periodically or based on a change in the link status of at least one of the communication links of at least one of the other network devices. The link status database 416 may be updated by incorporating the change in the link status of at least one of the communication links of at least one of the other network devices. The change in the link status may be determined by comparing the second LSI 422 with a previously received second LSI stored in the link status database 416. Alternatively, the link status database 416 may be updated by replacing the previously received second LSI with the second LSI 422.

In still additional embodiments, the network device 402 may be further configured to transmit the first LSI 420 and the second LSI 422 to at least one host device (for example, a server) in the DSF cluster. Each of the plurality of host-side ports (e.g., HS Port_1-HS Port_N) may transmit the first LSI 420 and the second LSI 422 to the same ordinal processing units (for example, GPUs) in the set of host devices. In many further embodiments, the network device 402 may be configured to transmit the first LSI 420 and the second LSI 422 to the same ordinal processing units in the set of host devices via an LLDP message. The first LSI 420 and the second LSI 422 may be included in an Organizationally Unique ID (OUI) Type-Length-Value (TLV) field of the LLDP message. The LLDP message may have additional fields to indicate a server plane ID, a sequence ID, and a rail ID associated with the network device 402.

Although a specific embodiment of a network device (a leaf switch or node) suitable for carrying out the various steps, processes, methods, and operations described herein is discussed with respect to FIG. 4, any of a variety of systems and/or processes may be utilized in accordance with embodiments of the disclosure. For example, in many additional embodiments, the network device 402 may be further configured to generate a unified LSI based on the first LSI 420 and the second LSI 422. The unified LSI may be a combination of the first LSI 420 and the second LSI 422. The unified LSI may be transmitted by the network device 402 to at least one connected host device (for example, a server) in the DSF cluster. Although the link status propagation logic 414 is shown to be included in the memory 406, the scope of the disclosure is not limited to it. In yet more embodiments, the link status propagation logic 414 can be configured as a standalone device, exist as a logic in another network device, be distributed among various network devices operating in tandem, or remotely operated as part of a cloud-based network management tool. In many additional examples, the link status propagation logic 414 can be implemented as a standalone component within the network device 402. The elements depicted in FIG. 4 may also be interchangeable with other elements of FIGS. 1-3 and 5-9 as required to realize a particularly desired embodiment.

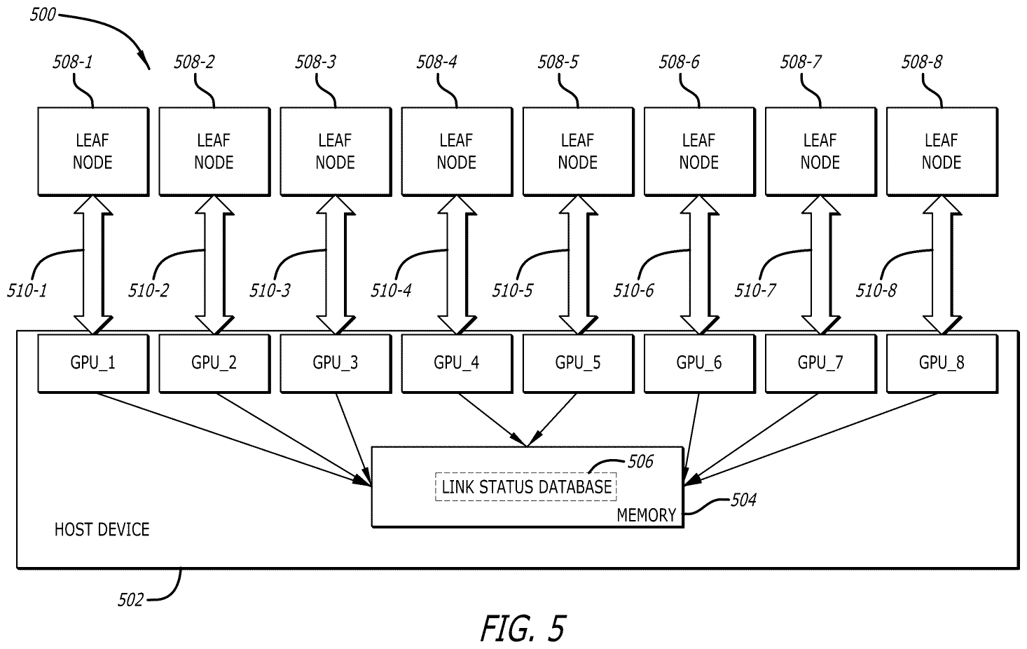

Referring to FIG. 5, a schematic diagram 500 of a host device 502 in accordance with various embodiments of the disclosure is shown. The embodiments shown in FIG. 5 illustrate a scenario where the host device 502 may be a server in a DSF cluster. The host device 502 may include one or more processing units, for example, GPU_1-GPU_8. The host device 502 may further include a memory 504 that may store a link status database 506.

In many embodiments, the GPU_1-GPU_8 may be communicatively coupled to a plurality of leaf nodes 508-1-508-8 via communication links 510-1-510-8, respectively. For example, the GPU_1 may be communicatively coupled with the leaf node 508-1 via the communication link 510-1. Likewise, the GPU_8 may be communicatively coupled with the leaf node 508-8 via the communication link 510-8. Further, the plurality of leaf nodes 508-1-508-8 may be associated with distinct rail IDs. For example, the plurality of leaf nodes 508-1-508-8 may be associated with rail IDs ‘R1’ through ‘R8’, respectively.

In several embodiments, the memory 504 may be configured to store one or more computer-readable instructions or routines in a non-transitory computer-readable storage medium, which may be fetched and executed for link status information aggregation. The memory 504 may include any non-transitory storage device including, for example, volatile memory such as RAM, a ROM, or non-volatile memory such as EPROM, a HDD, a flash memory, a solid-state memory, and the like. It will be apparent to a person skilled in the art that the scope of the disclosure is not limited to realizing the memory 504 in the host device 502, as described herein. In a variety of embodiments, the memory 504 may be realized in the form of a database server or a cloud storage working in conjunction with the host device 502, without departing from the scope of the disclosure.

In more embodiments, the host device 502 may receive link status information from the plurality of leaf nodes 508-1-508-8. In still more embodiments, each of the GPU_1-GPU_8 may receive the link status information from a connected leaf node for a specific rail ID. For example, the link status information received by the GPU_1 from the leaf node 508-1 having rail ID ‘R1’, via the communication link 510-1, may be indicative of link statuses of communication links associated with the leaf node 508-1 and link statuses of communication links associated with other leaf nodes in the DSF cluster that may have the same rail ID ‘R1’ as the leaf node 508-1. Likewise, the link status information received by the GPU_8 from the leaf node 508-8 having rail ID ‘R8’, via the communication link 510-8, may be indicative of link statuses of communication links associated with the leaf node 508-8 and link statuses of communication links associated with other leaf nodes in the DSF cluster that may have the same rail ID ‘R8’ as the leaf node 508-8.

In additional embodiments, the host device 502 may aggregate the link status information received by each of the processing units GPU_1-GPU_8, for example, in the link status database 506. Since the link status information received by each GPU_1-GPU_8 corresponds to a specific rail ID, the aggregated link status information may be indicative of link statuses of all host-side links in the DSF cluster. Hence, based on the aggregated link status information, the host device 502 may be aware of the link status of each host-side link in the DSF cluster.

Although a specific embodiment of an example host device suitable for carrying out the various steps, processes, methods, and operations described herein is discussed with respect to FIG. 5, any of a variety of systems and/or processes may be utilized in accordance with embodiments of the disclosure. For example, in further embodiments, the processing units (e.g., GPU_1-GPU_8) in the host device 502 may receive the link status information from associated leaf nodes in the form of multiple packets or frames. In such a scenario, each processing unit may assemble the packets or frames to determine the link status information. The elements depicted in FIG. 5 may also be interchangeable with other elements of FIGS. 1-4 and 6-9 as required to realize a particularly desired embodiment.

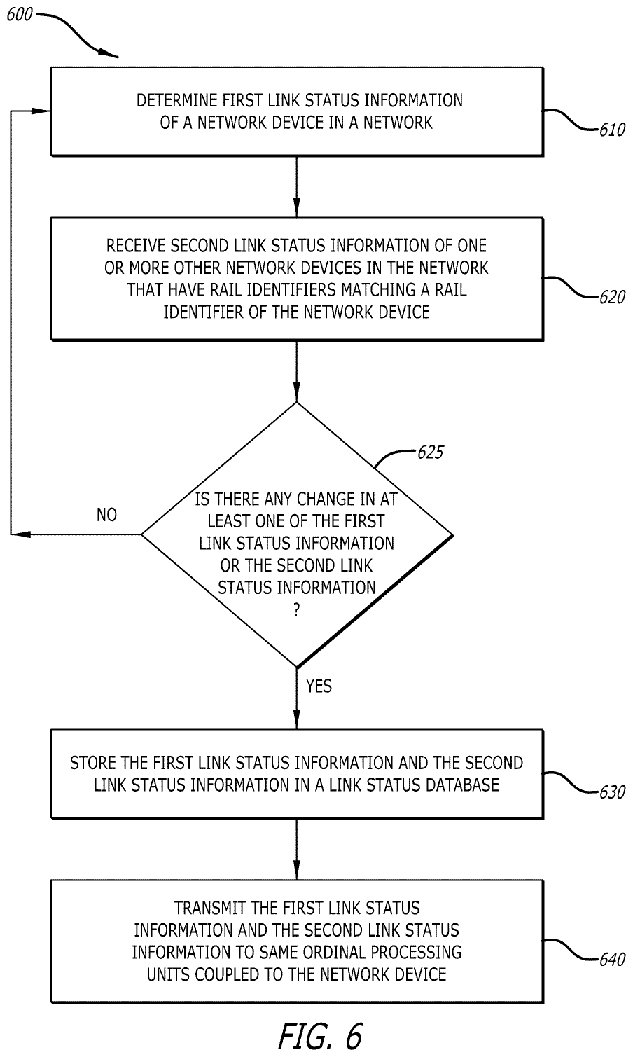

Referring to FIG. 6, a flowchart showing a process 600 for propagating link status information in a network fabric cluster in accordance with various embodiments of the disclosure is shown. In many embodiments, the process 600 may determine first link status information of a network device in a network (block 610). The network may be a DSF cluster and the network device may be a leaf node (e.g., a leaf switch) in the DSF cluster. In numerous embodiments, the DSF cluster may be built on a rail-based network architecture. Thus, the network device, including a plurality of ports, may be coupled to the same ordinal processing units in a set of host devices (e.g., servers, endpoint devices, etc) in the DSF cluster. The network device and the set of host devices may be part of a server plane. In the rail-based network architecture, the network device may be referred to as a rail and may be associated with a rail ID. The process 600 may determine the first link status information of a plurality of communication links of the network device. The first link status information may be indicative of a link status (e.g., active or inactive) of at least one communication link of the network device. In several embodiments, the process 600 may utilize one or more techniques for determining the first link status information, for example, LLDP messaging, Ethernet link status monitoring, monitoring protocol-specific keepalive messages, SNMP messaging, or the like. In more embodiments, the process 600 may be further configured to store the first link status information in a link status database of the network device.

In a number of embodiments, the process 600 may receive second link status information of one or more other network devices in the network that have rail IDs matching the rail ID of the network device (block 620). The second link status information may indicate link statuses of communication links of those network devices that have rail IDs matching the rail ID of the network device. In a variety of embodiments, the process 600 may store the second link status information in the link status database. The second link status information may be indictive of the active or inactive status of communication links of the other network devices that share the rail ID with the network device.

In various embodiments, the process 600 may determine whether there is any change in at least one of the first link status information or the second link status information (block 625). The change in the first link status information and/or the second link status information may be determined by comparing the determined first link status information and the received second link status information with previously stored first link status information and second link status information, respectively, in the link status database. A change in the first link status information may indicate a change in the status of at least one link associated with the network device. Further, a change in the second link status information may indicate a change in the status of at least one link associated with the one or more other network devices that share the rail ID with the network device. In yet various embodiments, if the process 600 determines that the first link status information and the second link status information have not changed, the process 600 may continue determining the first link status information and receiving the second link status information (block 610).

In additional embodiments, if the process 600 determines that either the first link status information and/or the second link status information has changed, the process 600 may store the first link status information and the second link status information in the link status database stored in a memory of the network device (block 630). The first link status information and the second link status information may, collectively, indicate link statuses of host-side links associated with a specific rail ID, for example, the rail ID of the network device. Further, the process 600 may be executed at the network device, for example, the leaf node.

In numerous additional embodiments, the process 600 may transmit the first link status information and the second link status information to the same ordinal processing units coupled to the network device (block 640). The process 600 may transmit the first link status information and the second link status information, which include link statuses of host-side links associated with a specific rail ID, for example, the rail ID of the network device. In further embodiments, the process 600 may transmit the first link status information and the second link status information to the same ordinal processing units by way of an LLDP message. The first link status information and the second link status information may be included in an OUI TLV field of the LLDP message. The LLDP message may have additional fields to indicate a server plane ID, a sequence ID, and a rail ID associated with the network device.

Although a specific embodiment for propagating link status information in a network fabric cluster suitable for carrying out the various steps, processes, methods, and operations described herein is discussed with respect to FIG. 6, any of a variety of systems and/or processes may be utilized in accordance with embodiments of the disclosure. For example, in still more embodiments, the process 600 may communicate the first link status information and the second link status information based on a nudge signal received from a host device in the DSF cluster. The elements depicted in FIG. 6 may also be interchangeable with other elements of FIGS. 1-5 and 7-9 as required to realize a particularly desired embodiment.

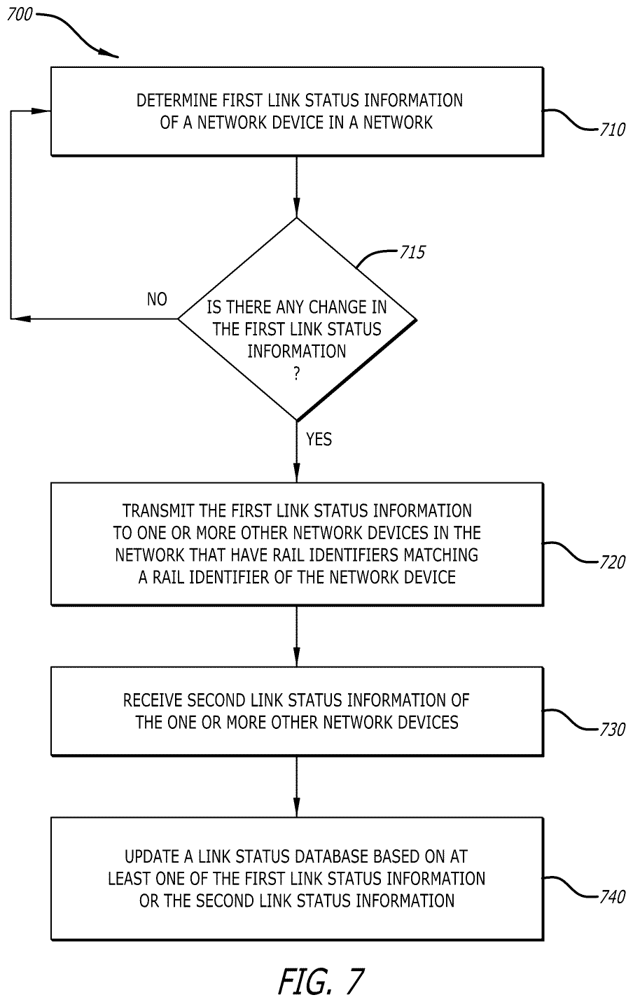

Referring to FIG. 7, a flowchart showing a process 700 for propagating link status information in a network fabric cluster in accordance with various embodiments of the disclosure is shown. In many embodiments, the process 700 may determine first link status information of a network device in a network (block 710). The network may be a DSF cluster and the network device may be a leaf node (e.g., a leaf switch) in the DSF cluster. In numerous embodiments, the DSF cluster may be built on a rail-based network architecture. Thus, the network device, including a plurality of ports, may be coupled to same ordinal processing units in a set of host devices (e.g., servers, endpoint devices, etc.) in the DSF cluster. In the rail-based network architecture, the network device may be referred to as a rail and may be associated with a rail ID. The process 700 may determine the first link status information associated with communication links of the network device. The first link status information may be indicative of a link status of at least one of the communication links of the network device. In several embodiments, the process 700 may utilize one or more techniques for determining the first link status information, for example, LLDP messaging, Ethernet link status monitoring, monitoring protocol-specific keepalive messages, SNMP messaging, or the like. In more embodiments, the process 700 may be further configured to store the first link status information in a link status database of the network device.

In various embodiments, the process 700 may determine whether there is any change in the first link status information (block 715). The change in the first link status information may be determined by comparing the first link status information with a previously determined first link status information that may have been stored in the link status database. In several more embodiments, if the process 700 determines that the first link status information is the same as the previously stored first link status information, the process 700 may continue determining the first link status information (block 710).

In additional embodiments, if the process 700 determines a change in the first link status information, the process 700 may transmit the first link status information to one or more other network devices in the DSF cluster that may have rail IDs matching the rail ID of the network device (block 720). A change in the first link status information may indicate a change in the status of at least one link associated with the network device. The process 700 may transmit the first link status information to the one or more other network devices via a network-side interface. The process 700 may transmit the first link status information by transmitting a message to the one or more other network devices. The message may be indicative of the first link status information. The message may further include a rail ID of the network device. The message may further include a sequence ID configured to maintain an order of delivery of the message. An out-of-order sequence ID may be indicative of a missing message or a stale message. A message with a sequence ID, older than a previously received message, may be discarded. The sequence ID may indicate relevance and timeliness of the first link status information. In further embodiments, the message may further include a server plane ID indicating a server plane to which the network device belongs.

In many further embodiments, the process 700 may receive second link status information of the one or more other network devices (block 730). The second link status information may indicate link statuses of communication links of the one or more other network devices in the DSF cluster that may have the rail IDs matching the rail ID of the network device. In many additional embodiments, the second link status information may be received via the network-side interface of the network device.

In numerous additional embodiments, the process 700 may update the link status database based on at least one of the first link status information or the second link status information (block 740). The process 700 may update the link status database by incorporating a change in the first link status information and/or the second link status information in the link status database. In further additional embodiments, the link status database may be updated by replacing previously stored first link status information and/or the second link status information with the determined first link status information and the received second link status information. Beneficially, such update ensures that the link status database stores the latest link status information at all times.

Although a specific embodiment for propagating link status information in a network fabric cluster suitable for carrying out the various steps, processes, methods, and operations described herein is discussed with respect to FIG. 7, any of a variety of systems and/or processes may be utilized in accordance with embodiments of the disclosure. For example, in still more embodiments, the process 700 may query a connected host device to receive link status information associated with other rail IDs that are different from the rail ID of the network device. The elements depicted in FIG. 7 may also be interchangeable with other elements of FIGS. 1-6 and 8-9 as required to realize a particularly desired embodiment.

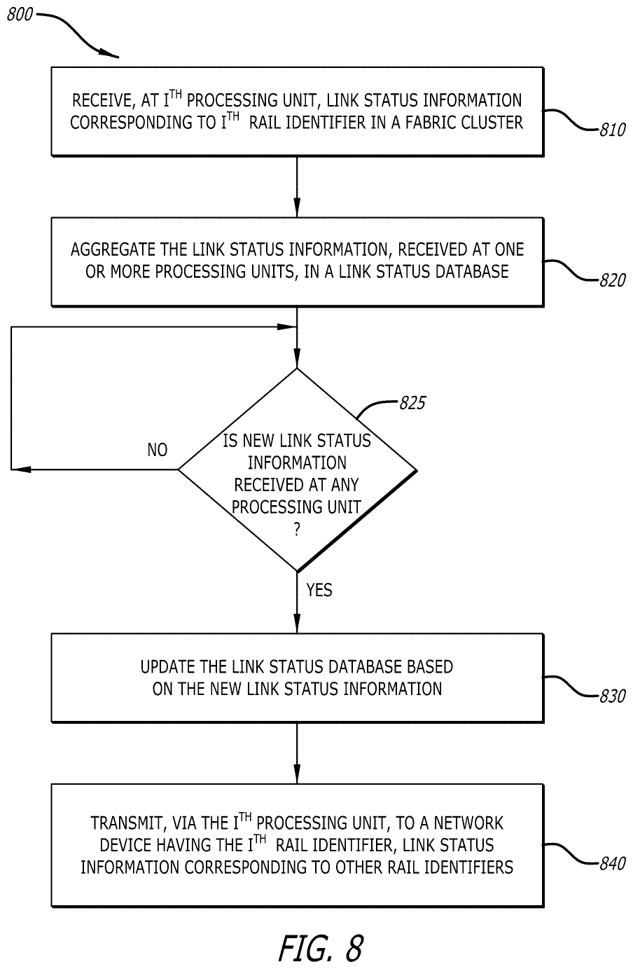

Referring to FIG. 8, a flowchart showing a process 800 for aggregating cluster wide link status information in a host device in accordance with various embodiments of the disclosure is shown. In many embodiments, the process 800 may receive, at i^{th} processing unit of a host device, link status information corresponding to i^{th} rail ID in a fabric cluster (block 810). In an example, the fabric cluster can be a DSF cluster. Here, “i^{th} processing unit” can be any of one or more processing units included in the host device. Further, the i^{th} rail ID may correspond to a rail ID of a leaf node connected to the i^{th} processing unit via a communication link. In a number of embodiments, the link status information received by the i^{th} processing unit may be indicative of link statuses of communication links of the leaf node connected to the i^{th} processing unit and link statuses of communication links of one or more other leaf nodes having rail IDs that match the i^{th} rail ID. Thus, the process 800 may receive link status information from the one or more processing units in the host device.

In a variety of embodiments, the process 800 may aggregate the link status information, received at the one or more processing units, in a link status database (block 820). The process 800 may store the link status information received at each of the one or more processing units to aggregate cluster wide link statuses of host-side communication links. The process 800 may store the link status information received by the one or more processing units on a rail ID basis in the link status database. For example, link status information associated with a first rail ID may be stored against the first rail ID and the link status information associated with a second rail ID may be stored against the second rail ID, in the link status database. Such storage may enable easy retrieval of link status information based on rail IDs.

In further embodiments, the process 800 may determine whether new link status information is received at any processing unit of the one or more processing units in the host device (block 825). In more embodiments, if the new link status information is not received at any processing unit, the process 800 may again determine whether the new link status information is received (block 825).

However, if the new link status information is received at any of the one or more processing units in the host device, in many further embodiments, the process 800 may update the link status database based on the new link status information (block 830). Notably, the new link status information may be different than the link status information stored in the link status database. The link status database may be updated by incorporating a difference between the new link status information and the stored link status information in the stored link status information. Alternatively, the link status database may be updated by replacing the stored link status information with the new link status information.

In additional embodiments, the process 800 may transmit, via the i^{th} processing unit, to a network device having the i^{th} rail identifier, link status information corresponding to other rail identifiers (block 840). For example, the i^{th} processing unit may be coupled to the network device having the i^{th} rail ID. In such a scenario, in response to receiving a query from the network device for one or more specific rail IDs other than the i^{th} rail ID, the process 800 may cause the i^{th} processing unit to retrieve the link status information corresponding to the one or more specific rail IDs from the link status database and transmit to the network device having the i^{th} rail ID the retrieved link status information. In still more embodiments, the process 800 may transmit the retrieved link status information to the network device via the communication link between the network device and the i^{th} processing unit. In yet more embodiments, the process 800 may transmit the retrieved link status information to the network device by way of an LLDP message. For example, the retrieved link status information may be included in an QUI TLV field of the LLDP message.

Although a specific embodiment for aggregating cluster wide link status information in a host device suitable for carrying out the various steps, processes, methods, and operations described herein is discussed with respect to FIG. 8, any of a variety of systems and/or processes may be utilized in accordance with embodiments of the disclosure. For example, in still further embodiments, the host device may utilize the aggregated link status information for checkpointing and workload planning. The elements depicted in FIG. 8 may also be interchangeable with other elements of FIGS. 1-7 and 9 as required to realize a particularly desired embodiment.

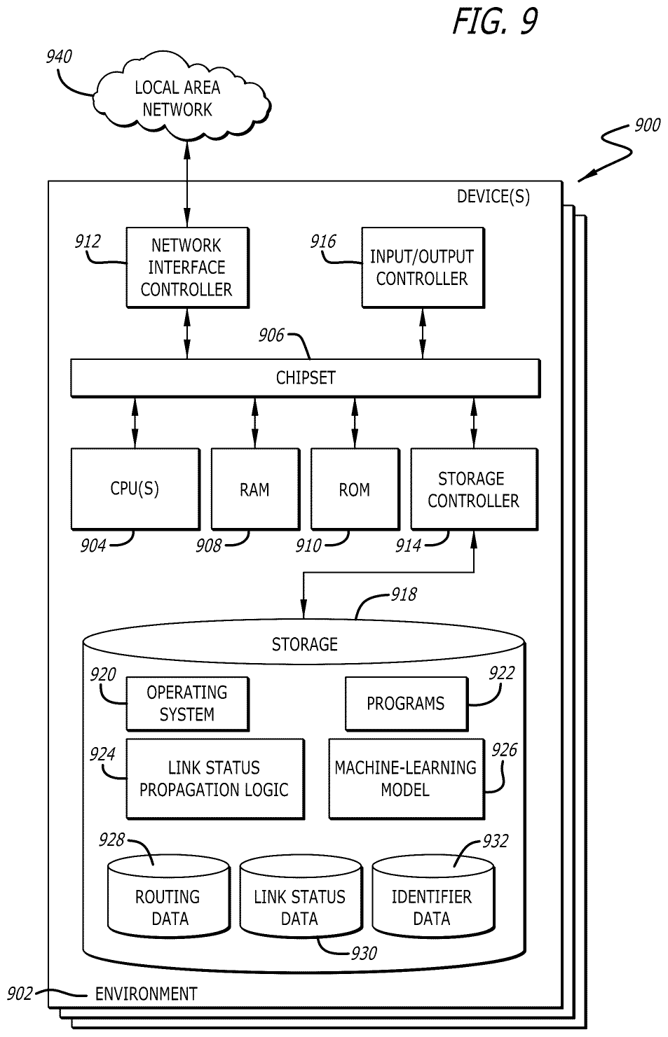

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations required for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in additional embodiments. The chipset 906 can further be configured to provide an interface to a computer-readable storage medium such as a read-only memory (“ROM”) 910 or non-volatile RAM (“NVRAM”) 908 for storing basic routines that can help with various tasks such as, but not limited to, starting up the device 900 and/or transferring information between the various components and devices. The ROM 910 or NVRAM 908 can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, and data 928, 930, 932, which are described in greater detail below. The storage 918 can be connected to the environment 902 through a storage controller 914 connected to the chipset 906. In various embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In additional embodiments, the device 900 has access to computer-readable storage media storing computer-executable instructions which, when executed by the device 900, perform the various processes described above with regard to FIGS. 1-8. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform the functions described herein. The virtualization layer may generally support a virtual resource that performs at least a portion of the techniques described herein.

In many embodiments, the device 900 can include a link status propagation logic 924 that can be configured to perform one or more of the various steps, processes, operations, and/or other methods that are described above. Often, the link status propagation logic 924 can be a set of instructions stored within a non-volatile memory that, when executed by the processor(s)/controller(s) 904 can carry out these steps, etc. In additional embodiments, the link status propagation logic 924 may be a client application that resides on a network-connected device, such as, but not limited to, a server, switch, personal or mobile computing device, or an access point (AP). In various embodiments, the link status propagation logic 924 can utilize tracerouting tools and applications known in the art to trace a network protocol supported by a subsequent device or determine an address of a source of a received error response packet.

In several embodiments, the link status propagation logic 924 may determine a first link status information associated with host-side communication links of the device 900 (for example, a leaf node or switch). The link status propagation logic 924 may be configured to receive second link status information of one or more other network devices in a network fabric that have rail IDs matching a rail ID of the device 900. The link status propagation logic 924 may be further configured to store the first link status information and the second link status information in the storage 918. The link status propagation logic 924 may be further configured to update the stored the first link status information or the second link status information based on the change in any of the first link status information or the second link status information. The link status propagation logic 924 may be further configured to transmit the first link status information to the one or more other network devices. Additionally, the link status propagation logic 924 may be further configured to transmit the first link status information and the second link status information to the same ordinal processing units of a set of host devices (for example, servers) connected to the device 900.

In further embodiments, where the device 900 is a host device including a plurality of processing units (e.g., GPUs), the link status propagation logic 924 may be configured to receive link status information of a connected network node (e.g., a leaf node) and a set of other network nodes that have rail IDs matching a distinct rail ID of the connected network node at each GPU. The link status propagation logic 924 may be further configured to aggregate the link status information received at each of the GPUs and store it in the storage 918.

In a number of embodiments, the storage 918 can include routing data 928. In additional embodiments, the routing data 928 can include information, for example, routing tables. Routing table may contain various entries that map destination IP addresses to next hop or outgoing ports. Routing tables may enable the device 900 to make packet forwarding decisions. MAC address table is an example of a routing table. MAC address table may include destination MAC addresses mapped to corresponding switch ports. The routing data 928 may further store a mapping between IP addresses and MAC addresses within a network. Such mapping may be utilized to translate IP addresses to MAC addresses for proper forwarding of packets.

In various embodiments, the storage 918 can include link status data 930. In several embodiments, the link status data 930 can comprise information regarding the link statuses of host-side communication links of one or more leaf nodes. In embodiments where the device 900 is a leaf node, the link status data 930 may include rail-based tracking of link status information. In other words, the link status data 930 may store link status information corresponding to leaf nodes having a specific rail ID, for example, the rail ID of the device 900. However, in embodiments where the device 900 is a host device connected to a leaf node, the link status data 930 may include cluster wide tracking of link status information of host-side communication links. The link status data 930 may be organized in accordance with one or more data organization techniques known in the art. The link status data 930 may be updated periodically or based on a change in the link status of at least one link of one or more leaf nodes in the network fabric cluster. In numerous embodiments, the link status data 930 may be organized by using rail IDs as the primary key.

In still more embodiments, the storage 918 can include identifier data 932. The identifier data 932 may include rail IDs and server plane IDs associated with the network fabric cluster. The identifier data 932 can enable the device 900 to manage the server planes, rails, links, topology, or the like in the network fabric cluster.

Finally, in many embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to learn one or more patterns of link failures based on the link status data 930. Based on the learned pattern, the ML model 926 may be further configured to deduce one or more rules to predict the failure of links in the network fabric cluster. Based on the one or more rules, the ML model 926 may predict link failures that may occur during a defined time interval in the future.

The ML model(s) 926 can be configured to generate inferences to make predictions or draw conclusions from data. An inference can be considered the output of a process of applying a model to new data. This can occur by learning from infrastructure data, sustainability data, and/or health data and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a plurality of ports coupled to same ordinal processing units in a set of host devices in a rail-based network topology; and
a memory communicatively coupled to the processor, wherein the memory comprises a link status propagation logic that is configured to:
determine first link status information of the network device, wherein the network device is associated with a rail identifier;
receive second link status information of one or more other network devices that have rail identifiers matching the rail identifier of the network device; and
transmit the first link status information and the second link status information to the same ordinal processing units.

2. The network device of claim 1, wherein the link status propagation logic transmits the first link status information and the second link status information to the same ordinal processing units via a Link Layer Discovery Protocol (LLDP) message.

3. The network device of claim 2, wherein the first link status information and the second link status information are included in an Organizationally Unique Identifier (OUI) Type-Length-Value (TLV) field of the LLDP message.

4. The network device of claim 1, wherein the link status propagation logic is further configured to transmit a message to the one or more other network devices that have the rail identifiers matching the rail identifier of the network device, the message being configured to indicate the first link status information.

5. The network device of claim 4, wherein the message includes a sequence identifier configured to maintain an order of delivery.

6. The network device of claim 4, wherein the message is further configured to indicate the rail identifier of the network device.

7. The network device of claim 4, wherein the network device and the set of host devices are a part of a server plane.

8. The network device of claim 7, wherein the message is further configured to indicate a server plane identifier associated with the server plane.

9. The network device of claim 1, wherein the memory is further configured to store a link status database.

10. The network device of claim 9, wherein the link status propagation logic is further configured to store the first link status information and the second link status information in the link status database.

11. The network device of claim 9, wherein the link status propagation logic is further configured to update the link status database in response to receiving the second link status information.

12. The network device of claim 9, wherein the link status propagation logic is further configured to update the link status database in response to determining the first link status information.

13. The network device of claim 1, wherein the plurality of ports are coupled to the same ordinal processing units via a set of communication links.

14. The network device of claim 13, wherein the first link status information is configured to indicate a status of at least one of the set of communication links.

15. The network device of claim 14, wherein the status is one of active or inactive.

16. The network device of claim 13, wherein the first link status information and the second link status information are transmitted to the same ordinal processing units via the set of communication links.

17. The network device of claim 1, wherein the network device is a leaf node in a Disaggregated Scheduled Fabric (DSF) cluster.

18. A host device, comprising:
one or more processing units, each coupled to a distinct network node having a distinct rail identifier; and
a memory communicatively coupled to the one or more processing units, wherein the memory comprises a link status propagation logic that is configured to:
receive, at each of the one or more processing units, link status information of the distinct network node and a set of other network nodes that have rail identifiers matching the distinct rail identifier; and
aggregate the link status information received at each of the one or more processing units.

19. The host device of claim 18, wherein the memory further comprises a link status database configured to store the aggregated link status information.

20. A link status propagation method, comprising:
determining first link status information of a network device in a network, wherein the network device is associated with a rail identifier and coupled to same ordinal processing units in a set of host devices;
receiving second link status information of one or more other network devices, in the network, that have rail identifiers matching the rail identifier of the network device; and
transmitting the first link status information and the second link status information to the same ordinal processing units.
